(19) United States
(12) Patent Application Publication
(10) Pub. No.: US 2025/0080904 A1
(43) Pub. Date: Mar. 6, 2025

(54) Capturing Spatial Sound on Unmodified Mobile Devices with the Aid of an Inertial Measurement Unit

(71) Applicant: Google LLC, Mountain View, CA (US)

(72) Inventors: Artem Dementyev, Boston, MA (US); Richard Francis Lyon, Los Altos, CA (US); Pascal Tom Getreuer, San Francisco, CA (US); Alex Olwal, Santa Cruz, CA (US); Dmitrii Nikolayevitch Votintcev, San Francisco, CA (US)

(21) Appl. No.: 18/460,280

(22) Filed: Sep. 1, 2023

(51) Int. Cl. H04R 1/40

(52) U.S. Cl. CPC H04R 1/406

(57) ABSTRACT

The present disclosure provides computer-implemented methods, systems, and devices for capturing spatial sound for an environment. A computing system captures, using two or more microphones, audio data from an environment around a mobile device. The computing system analyzes the audio data to identify a plurality of sound sources in the environment around the mobile device based on the audio data. The computing system determines, based on characteristics of the audio data and data produced by one or more movement sensors, an estimated location for each respective sound source in the plurality of sound sources. The computing system generates a spatial sound recording of the audio data based, at least in part, on the estimated location of each respective sound source in the plurality of sound sources.

### FIELD

The present disclosure relates generally to capturing spatial sound using a user computing device.

### BACKGROUND

User computing devices have improved by increasing processing power and utility. The improvements in technology can allow user computing devices to capture information about the surrounding environment more accurately using sensors. However, to capture spatial sound, user computing devices have historically needed cumbersome and expensive sound detection systems. The increase in cost and decrease in mobility have rendered such systems unworkable for modern user computing devices (e.g., smartphones).

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method. The method can include capturing, by a computing system including one or more processors using two or more microphones, audio data from an environment around a mobile device. The method can include analyzing, by the computing system, the audio data to identify a plurality of sound sources in the environment around the mobile device based on the audio data. The method can include determining, by the computing system and based on characteristics of the audio data and data produced by one or more movement sensors, an estimated location for each respective sound source in the plurality of sound sources. The method can include generating, by the computing system, a spatial sound recording of the audio data based, at least in part, on the estimated location of each respective sound source in the plurality of sound sources.

Another example aspect of the present disclosure is directed at a mobile device. The mobile device can include one or more processors, two or more audio sensors; one or more movement sensors, and one or more non-transitory computer-readable media that collectively store instructions that, when executed by the one or more processors, cause the computing system to perform operations. The operations can include capturing, using the two or more audio sensors, audio data from an environment around the mobile device. The operations can include analyzing the audio data to identify a plurality of sound sources in the environment around the mobile device based on the audio data. The operations can include determining, based on characteristics of the audio data and data produced by the one or more movement sensors, an estimated location for each respective sound source in the plurality of sound sources. The operations can include generating a spatial sound recording of the audio data based, at least in part, on the estimated location of each respective sound source in the plurality of sound sources.

Another example aspect of the present disclosure is directed to one or more non-transitory computer-readable media that collectively store instructions that, when executed by one or more computing devices, cause the one or more computing devices to perform operations. The operations can include capturing, using the two or more audio sensors, audio data from an environment around the mobile device. The operations can include analyzing the audio data to identify a plurality of sound sources in the environment around the mobile device based on the audio data. The operations can include determining, based on characteristics of the audio data and data produced by the one or more movement sensors, an estimated location for each respective sound source in the plurality of sound sources. The operations can include generating a spatial sound recording of the audio data based, at least in part, on the estimated location of each respective sound source in the plurality of sound sources.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices for implementing and utilizing user computing devices.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which refers to the appended figures, in which:

FIG. 1 depicts an example user computing system in accordance with example embodiments of the present disclosure.

FIG. 2A illustrates an example environment in which audio data, video data, and movement data are captured in accordance with example embodiments of the present disclosure.

FIG. 2B illustrates an example sound source location estimation map in accordance with example embodiments of the present disclosure.

FIG. 3 illustrates an example audio analysis system in accordance with example embodiments of the present disclosure.

FIG. 4 is an example of a smartphone with two microphones in accordance with example embodiments of the present disclosure.

FIG. 5A is an example of a user interface for displaying movement instructions to a user in accordance with example embodiments of the present disclosure.

FIG. 5B is an example of a user interface for displaying movement instructions to a user in accordance with example embodiments of the present disclosure.

FIG. 6 depicts an example client-server environment according to example embodiments of the present disclosure.

FIG. 7 is a flowchart depicting an example process of capturing audio data and generating a spatial sound recording in accordance with example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed towards a system for capturing spatial sound using audio sensors included in a standard mobile device. Note that in this context capturing spatial sound refers to capturing audio data from a three-dimensional environment in a way that retains the spatial characteristics of the audio data in that three-dimensional environment. To capture spatial sound accurately, an unmodified user computer device (e.g., a smartphone or other mobile computing device) may include at least two audio sensors. These audio sensors can be spaced on the case or body of the user computing device such that sound from a particular source will arrive at slightly different times to each audio sensor. The user computing device can also include a motion sensor and an image sensor (e.g., a camera).

An audio analysis system can capture audio data representing the sound in the environment of the user computing device using two or more audio sensors included in the user computing device. The audio analysis system can analyze the captured audio data. As part of this analysis, the audio analysis system can analyze the audio data to distinguish a plurality of different sound sources within the audio data. The audio analysis system can distinguish particular sound sources based, at least partially, on the time at which sounds arrive at each of the audio sensors, characteristics of the sounds themselves (e.g., volume, pitch, timbre, and so on), and information from the movement sensor can allow the audio analysis system to identify a plurality of sound sources in the audio data. In some examples, the user computing device can also capture image data (e.g., using a camera). The image data can also be used to distinguish different sounds sources within the audio data.

For each respective sound source in the plurality of sound sources, the audio analysis system can estimate a location of the respective sound source. This estimated location can be based on the time at which sounds associated with the source arrived at each audio sensor and data captured by the motion sensor. Image data can also be used if available.

An audio generation system can use the estimated location for each respective sound source to generate a spatial sound recording of the audio data. A spatial sound recording is an audio recording with two or more audio tracks intended to be transmitted to two or more different speakers. Examples of spatial sound recordings can include binaural recording. A binaural recording can be an example of a spatial sound recording intended to be played from two audio speakers (e.g., in headphones) to a user. The combination of at least two audio sensors and a movement sensor allows the user computer device to estimate the location of each sound source. These estimated locations can be used by the audio generation system to generate high-quality spatial sound recordings without any additional equipment.

For example, a user may wish to record the audio in an environment such that it can be used later to accurately reproduce the sound in that environment. In one example, a virtual reality application may wish to capture actual audio of a location to provide realistic audio for a virtual environment. Without any specialized equipment (dedicated ambisonic microphones or other expensive recording equipment) a user can use their smartphone to record audio data. While recording the user can also move and/or rotate the smartphone. The movements of the smartphone can be made either naturally by the user or based on instructions provided by an audio recording application running on the smartphone. The audio analysis system can analyze the audio data and compare it with the movement data to identify one or more sound sources. The audio analysis system can determine, for each audio source, an estimated location of the sound source in the three-dimensional environment (or relative to the smartphone). An audio generation system (associated with the audio analysis system) can use the audio data, the movement data, and the estimated location of the plurality of sound sources to generate a spatial sound recording of the audio data. The generated spatial sound recording can then be used to provide audio in a three-dimensional virtual environment.

More specifically, a user computing device can include any computing device that can be used by a user. User computing devices can include personal computers, laptops, smartphones, tablet computers, wearable computing devices, and so on. A wearable computing device can be any computing device that is integrated into an object that is meant to be worn by a user. For example, wearable computing devices can include, but are not limited to smartwatches, fitness bands, computing devices integrated into jewelry such as smart rings or smart necklaces, computing devices integrated into items of clothing such as jackets, shoes, pants, and wearable glasses with computing elements included therein.

The user computing device can include two or more audio sensors. The audio sensors can be microphones integrated into the user computing device. For example, a smartphone can have, as part of the case, two or more ports through which microphones can detect audio data. In some examples, the microphones are spaced apart on the case or body of the smartphone (or other mobile computing device). For example, a first microphone can be positioned at one end of the user computing device (e.g., at the bottom of the smartphone case or body) and a second microphone can be positioned at the other end of user computing device (e.g., the top of the smartphone case.) The microphones can be standard omnidirectional microphones that do not inherently provide any information as to the direction from which the audio data is detected.

The user computing device can include a motion sensor. The motion sensor can be an IMU (inertial measurement unit). The IMU can provide information on the orientation and position of the user computing device as well as the changes in either. In some examples, the IMU can use data from gyroscopes, accelerometers, and magnetometers along with a Kalman filter to detect changes in the user computing device's position and orientation.

In some examples, the user computing device can include an image sensor. The image sensor can capture image data (e.g., still images or video) while the user computing device is capturing audio data. The image data can be used to improve the estimated location of each sound source. For example, the image data can be analyzed to identify and classify any objects in the image data. The classified objects can be compared with the classifications of sound sources. Based on this comparison (and other contextual data), the audio analysis system can determine whether any of the classified objects in the image data match a sound source. If so, the position of the object within the image data can, along with information about the position and orientation of the image sensor, be used to update the estimated location of the sound source.

The user computer device can also include an application for recording audio data and generating spatial sound audio recordings for later playback. Such an application can include an audio analysis system and an audio generation system. The audio analysis system can analyze audio data recorded by two or more audio sensors to generate an estimation of the location of various sounds included in the audio data.

In some examples, the audio analysis system can identify different sound so und sources within audio data. The audio analysis system can use audio data that includes sounds from more than one sound source. The audio analysis system can identify a list of sound sources in the audio data. Each sound source can be associated with a list of sounds produced by that sound source in the audio data. Each sound can have an associated time at which the sound is located within the audio data. In some examples, the audio data can include audio data from more than one audio sensor. In this case, the list of sound sources and the associated sounds can include information identifying when each sound occurred in the audio data produced by each audio sensor. Depending on the type of sound source and the location of each sound source, the sound may be recorded by one of the audio sensors before the other sensors.

The audio analysis system can then classify each sound source based on the list of sounds associated with each sound source. In some examples, the classification system can determine a general type of sound source (e.g., mechanical, biological, natural, and so on). In other examples, the classification system can generate more specific information about the source (e.g., an older human male, a young robin, and so on). For example, a classification system can use characteristics identified with each sound as well as other contextual information to determine the likely type of sound source that produces each sound. For example, particular animals may have a distinctive sound that they make, and the classification system can determine that a particular sound source in audio data is that particular animal. Similarly, machines or objects with mechanically moving components may have a distinctive sound they produce that can be reliably distinguished by the classification model.

Once the sound sources have been separated and classified, the audio analysis system can determine a location for each sound source. This can be accomplished by analyzing the data produced by a plurality of different sensors. For example, the audio sensors can produce one stream of audio data for each microphone or other audio sensor. The different streams of audio data can then be compared to estimate a location for each sound source.

In some examples, using multiple audio sensors to estimate a location can be referred to as beamforming (e.g., discrete time beamforming). In some examples, beamforming can be used to estimate a direction by comparing audio delays between more than one microphone. In this example, the microphones are positioned far enough apart in the case of the user computing device that the audio data produced by one of the microphones can be compared to the audio produced by the other microphones. The comparison of the times at which the sound from a particular sound source arrives at each microphone can be used to estimate the direction and distance of the sound source relative to the user computing device. In some examples, a machine-learned model can be trained to provide location estimates for sound sources based on the audio data generated by the multiple audio sensors.

The audio analysis system can use the movement data provided by the movement sensor to increase the accuracy of the location estimation for each sound source. In some examples, the user computer device can be moved during the time in which audio data is being recorded. This movement can be based on the user's natural movement as they move through an environment (or interact with some aspect of it) or can be directed by the audio analysis system to help provide the audio analysis system with more accurate estimation. For example, the user computer device can be moved from a first position and orientation to a second position and orientation. The audio data recorded at the first position and orientation can differ from the audio data recorded at the second position and orientation. The audio analysis system can use the differences in the sounds measured from the sound source at the first position and orientation and the sounds measured at the second position and orientation to improve the accuracy of its estimation as to the direction and the distance of the sound source from the user computing device. For example, as a user computing device rotates, the time at which various sounds arrive at each microphone may change based on the position of the sound source. This information can be used to estimate the location of the sound source.

In another example, the user computing device can capture video of the environment as the sound is being recorded. For example, the sound can be recorded as part of capturing video of a location. The audio analysis system can analyze the captured image data (e.g., video or still images) to identify objects in that image data that match one or more identified sound sources. For example, if the voice of a person is one of the sound sources, the video data can be analyzed to determine a specific user in the video who matches the identified sound source. The audio analysis system can then determine the location of the person based on the video data in light of the other methods of estimating the location of the sound source.

In some examples, the audio data can be used to estimate a direction and the video data and movement data can be used to estimate a distance. In some examples, all three sources can be used together to estimate the direction and distance of the sound source from the user computing device. This can be performed for each of the plurality of sound sources that are determined from the audio data. As noted above, machine-learned models can be trained to take the audio data, video data, and movement data as input. The machine-learned model can produce, as output, an estimated location for each sound source.

The information determined from the audio data can be stored as a sound source location estimation map of the plurality of sound sources and their estimated location relative to the user computing device. The sound source location estimation map can then be used by an audio generation system to generate a spatial sound recording of the audio data for later playback.

A spatial sound recording is a recording that contains two or more different audio tracks, each track intended to be played from a different audio source (e.g., a speaker inside a headphone) to a user. A spatial sound recording generated by the audio generation system can provide the audio experience of hearing the sounds in the actual environment in which they were recorded, including the illusion of three-dimensionality. In some examples, the spatial sound recording can be played along with the display of image data (e.g., videos) of the environment in which the sound was captured. In other examples, the spatial sound recording can be used in a virtual reality experience or augmented reality experience.

Embodiments of the disclosed technology provide a number of technical effects and benefits, particularly in the areas of user computing devices. In particular, embodiments of the disclosed technology provide improved techniques for capturing spatial sound without dedicated hardware. For example, utilizing embodiments of the disclosed technology, a smartphone can capture sound from an environment and record it in such a way that it can be replayed to a user in a manner that recreates the experience of hearing the sounds in a real-world environment using a spatial sound recording. Accurately reproducing the sound of a three-dimensional environment can result in a better and more useful user experience. Furthermore, this effect is accomplished with relatively little cost. As such, the disclosed embodiments enable additional functionality without significantly increasing the total cost of a user computing device.

With reference now to the figures, example aspects of the present disclosure will be discussed in greater detail.

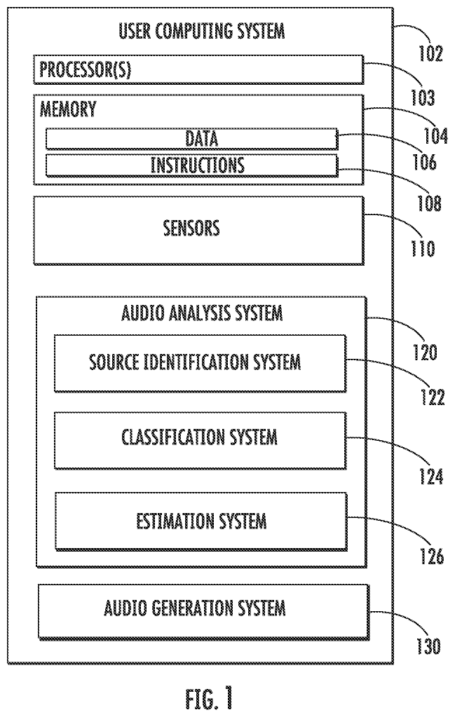

FIG. 1 depicts an example user computing device 102 in accordance with example embodiments of the present disclosure. In some example embodiments, the user computing device 102 can be any suitable device, including, but not limited to, a smartphone, a personal computing system, a tablet computing system, a wearable computing device, or any other computing system that is configured such that it can provide audio recording, analysis, and generation service to users. The user computing device 102 can include one or more processor(s) 103, memory 104, one or more sensors 110, an audio analysis system 120, and an audio generation system 130.

The one or more processor(s) 103 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store information accessible by the one or more processor(s) 103, including instructions 108 that can be executed by the one or more processor(s) 103. The instructions can be any set of instructions that when executed by the one or more processor(s) 103, cause the one or more processor(s) 103 to provide the desired functionality.

In particular, in some devices, memory 104 can store instructions for implementing the audio analysis system 120 and the audio generation system 130. The user computing device 102 can implement the audio analysis system 120 and the audio generation system 130 to execute aspects of the present disclosure, including capturing audio data from an environment, identifying a plurality of sound sources based on the audio data, classifying each sound source in the plurality of sound sources, estimating the location of each sound source, and generating a spatial sound recording of the sound data.

It will be appreciated that the terms “system” or “engine” can refer to specialized hardware, computer logic that executes on a more general processor, or some combination thereof. Thus, a system or engine can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as audio data, classification data, and audio generation data available to the audio analysis system 120 (e.g., data used to distinguish sound sources in audio data, classify various sound sources, and estimate the locations of the sound sources) and the audio generation system 130 (e.g., sound source location estimation maps, data that is used to generate a spatial sound recording based on the estimated locations of the sound sources, and so on), that can be retrieved, manipulated, created, or stored by the one or more processor(s) 103. In some example embodiments, such data can be transmitted to the user computing system as needed.

In some example embodiments, the user computing device 102 includes one or more sensors 110, an audio analysis system, and an audio generation system 130. The one or more sensors 110 can include two or more audio sensors, one or more movement sensors, and an image sensor. The two or more audio sensors can include two or more microphones mounted at different locations in the case of the user computing device. For example, if the user computing device is a smartphone, the smartphone can include a first microphone at the top of the smartphone and a second microphone at the bottom of the smartphone. In general, the further the first microphone is from the second microphone, the greater the different between the time at which audio data associated with a particular sound or sound source is detected or recorded by the first microphone and the time at which audio data associated with the particular sound or sound source is detected or recorded by the second microphone. For example, if a sound is generated by a sound source on the left, the delay between the sound being detected at the first microphone and the sound being detected at the second microphone will be greater if the first microphone is physically further away from the second microphone.

The movement sensors can include an inertial measurement unit (IMU). The IMU can provide information on the orientation and position of the user computing device as well as the changes in either. In some examples, the IMU can use data from gyroscopes, accelerometers, and magnetometers along with a Kalman filter to detect changes in the position and orientation of the user computing device 102. The information provided by the IMU can be used to estimate the position and orientation of the user computing device at a plurality of time steps associated with the audio data recorded by the two or more microphones. In some examples, the movement data can be correlated such that each time step in the audio data has associated movement data from the corresponding time step.

The image sensors can include one or more cameras. The cameras can capture image data including, but not limited to single frame images (e.g., pictures) and video data of the environment of the user computing devices. In some examples, the cameras can continuously capture video data from one or more cameras as the audio data is being captured. In some examples, the user computing device 102 can correlate the movement data of the user computing device 102 to the video data. The image data can be used by the user computing device to aid in classifying sound sources and estimating the location of each sound source.

The audio analysis system 120 can receive sensor data from the one or more sensors 110. The sensor data produced by the one or more sensors can include audio data, movement data, and video data. The audio analysis system 120 can analyze the audio data (with the data from other sensors as context) to identify various sound sources within the audio data. The audio analysis system 120 can estimate the location of each sound source. In some examples, the audio analysis system 120 can include a source identification system 122, a classification system 124, and an estimation system 126.

In some examples, the source identification system 122 can receive audio data from the audio sensor. The source identification system 122 can analyze the data to identify a plurality of sound sources in the audio data. In some examples, the source identification system 122 can include a machine-learned model that is trained to receive audio data and output a list of sound sources that have produced sounds captured in the audio data. In some examples, the source identification system 122 can also access the movement data and the video data associated with the audio data. This information can be used by the source identification system 122 to analyze the audio data to identify a plurality of sound sources.

Once a list of sound sources in the audio data has been generated, the classification system 124 can then classify, for each sound source in the list of sound sources, a sound source type or identification. For example, a sound source can include a person and may receive a “human being” classification. Sound types or classifications may include vehicles, animals, machines, and natural sounds all may receive separate classifications.

In some examples, the classification system 124 can classify sound sources based on the available information. In some examples, the classification system 124 can use the sound or audio video associated with that particular sound source, movement data associated with the times in which those sounds were detected, and any video data or image data associated with the area in which the sound source may be located. In some examples, the classification system 124 can analyze image data in the area of the user computing device 102 and identify particular objects within the image data. The classification system 124 can match particular sound sources to objects identified in the image data. In some examples, the sound classification system can match objects based on a type associated with a particular sound source. For example, if a particular sound source is determined to have the type “large dog,” the sound classification system may determine that it matches a large dog in the objects identified from the image data.

Once the list of sound sources has been identified and each sound source has been classified, the estimation system 126 can estimate a location for each sound source. This estimation can be performed based on the difference in timing for sounds reaching one of the microphones and the other microphone. In addition, the estimation system 126 can use movement data to further contextualize the audio data. The estimation system 126 can also use image tape to identify the potential or estimated location of each child source.

Once the estimation system 126 has estimated a location for each source in the period of sound sources, the audio analysis system 120 can generate a sound source location estimation map that represents the estimated location of each sound in the sources relative to the position of the user computing device 102. This sound source location estimation map may also associate specific sounds with each sound location. In some examples, the audio analysis system 120 can provide the sound source location estimation map to the audio generation system 130.

The audio generation system 130 can access the sound source location estimation map, along with any associated audio data. The audio generation system 130 can use the sound source location estimation map to generate a spatial sound recording of the sound. The spatial sound recording can include at least two channels of audio data, each channel intended to be played out of a different speaker device (e.g., one speaker of a set of headphones). In some examples, the spatial sound recording can be generated to be broadcast out of a particular speaker configuration. For example, the spatial sound recording can be generated such that the recording is an acceptable facsimile of the sound as it would be heard in the actual three-dimensional environment. In some examples, the audio generation system 130 can generate the spatial sound recording based on two or more speaker devices with a particular spacing. For example, the spatial sound recording can be generated to be played from two speakers in a set of headphones, with an expected distance apart based on the average distance between a user's ears.

In other examples, the spatial sound recording can be generated based on a known fixed set of speakers. For example, in a three-dimensional audio-visual experience, the position and distance of two or more speakers can be known and the audio generation system 130 can generate a spatial sound recording based on that known information to give a particular audio experience to a user (e.g., recreating the experience of hearing the sounds in a three-dimensional environment similar to the one in which the audio data was recorded). In some examples, the spatial sound recording can be personalized to a particular user or location based on input received from the user or measurements taken of the user or the location.

In some examples, the user computing device 102 can store the spatial sound recording for later use. In some examples, the spatial sound recording can be played back using the user computing device 102. In other examples, the spatial sound recording can be transmitted to another computing system via one or more communication networks.

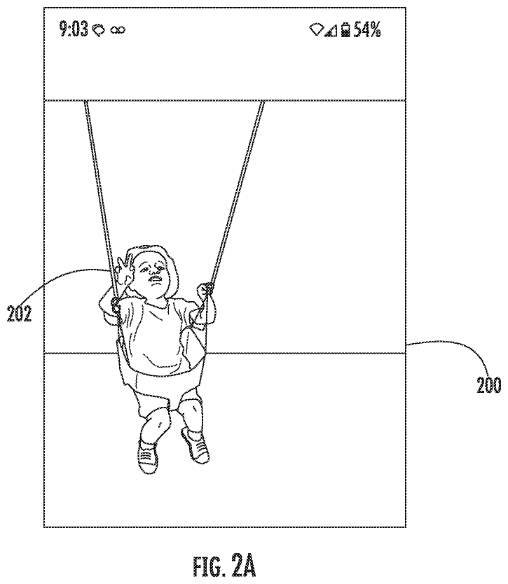

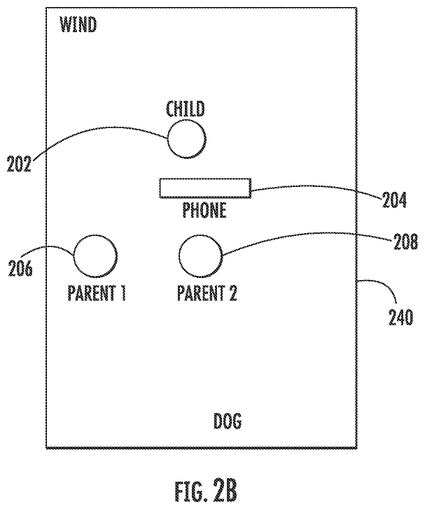

FIG. 2A illustrates an example environment in which audio data, video data, and movement data are captured in accordance with example embodiments of the present disclosure. In this example, a user computing device (e.g., user computing device 102 in FIG. 1) can capture sensor data from an environment. For example, the image sensor captures the image 200 of a child 202 on a swing. The child 202 and the swing can produce sound and thus be included in a list of sound sources.

In addition, the environment can include a plurality of sound sources not included in the image data. For example, the environment may include the parents of the child (e.g., holding the smartphone outside of the viewing area). In addition, the environment may include environmental noise (e.g., wind) or animals (e.g., the family dog). These sound sources can be identified, and their location can be estimated based on information received by the sensors.

FIG. 2B illustrates an example sound source location estimation map in accordance with example embodiments of the present disclosure. In this example, the sound source location estimation map 240 can represent the estimated location of each sound source. In this example, the smartphone 204 (e.g., a user computing device) is represented in the center of the sound source location estimation map. The child 202 (as seen in FIG. 2A) is in front of the smartphone 204. A first parent 206 and a second parent 208 are positioned behind the smartphone 204. In addition, a dog is determined to be in the area and the wind is audible in the sound. The sound source location estimation map can represent the estimated location of each sound source relative to the user computing device 102.

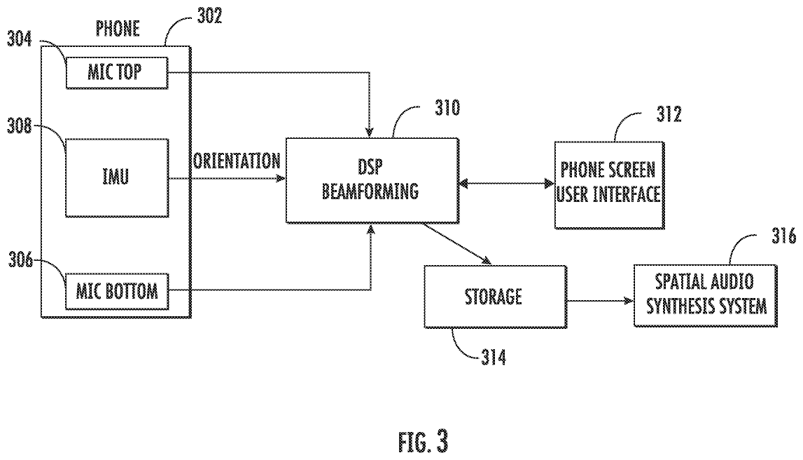

FIG. 3 illustrates an example audio analysis system 120 in accordance with example embodiments of the present disclosure. In this example, the user computing device is a smartphone 302. The smartphone 302 has a first audio sensor 304 at the top (referred to as “mic top”). The smartphone 302 also includes a second audio sensor 306 (referred to as the “mic bottom”) at the bottom of the case.

The smartphone 302 can also include a motion sensor. The motion sensor can be an inertial measurement unit (IMU) 308. The IMU can generate data representative of the orientation of the smartphone 302 at any given time. The first audio sensor 304, the second audio sensor 306, and the IMU 308 can provide sensor data to the beamforming system 310.

Using multiple audio sensors to estimate a location can be referred to as beamforming (e.g., discrete time beamforming). In some examples, the beamforming system 310 can therefore be used to estimate a direction by comparing audio delays between more than one audio sensor. In this example, the first audio sensor 304 and the second audio sensor 306 are positioned far enough apart on the smartphone 302 that the audio data produced by one of the audio sensors can be compared to the audio produced by the other audio sensors. The comparison of the times at which the sound from a particular sound source arrives at each audio sensor can be used to estimate a direction and a distance of the sound source.

In addition, the beamforming system 310 can use the IMU orientation data to estimate the position of one or more sound sources relative to the smartphone 302 based on the orientation of the smartphone 302 at the time at which various sounds were recorded. If a sound is recorded at the first audio sensor 304 before it was recorded by the second audio sensor 306, the orientation and position of the smartphone 302 can be used to determine the direction at which the sound source that produced that sound is located.

In some examples, the beamforming system 310 can output audio data, a list of sound sources, and an estimated location for each sound source. As noted above, the beamforming system 310 can use a sound source identification model to identify sound sources from the determined audio data. Similarly, a sound source classification model can be used to classify each sound source. The output of the beamforming system 310 can include a sound source location estimation map.

In some examples, the beamforming system 310 can determine that a change in the orientation of the smartphone 302 would enable a better estimation of the location of a particular sound source. In some examples, the beamforming system 310 can transmit instructions to the phone screen user interface 320 that directs the user how to orient their phone. The IMU 308 can determine when the user moves the smartphone, and that information can be provided to the beamforming system 310. Thus, if the user moves their phone incorrectly updates can be provided to the phone screen user interface 312.

Once the beamforming system 310 has adequately identified the list of sound sources and estimated their locations, the resulting sound source location estimation map can be stored in storage 314 associated with the user computing device. A spatial audio synthesis system 316 can be used to generate a spatial sound recording of the audio data using the sound source location estimation map in the storage 314 as a reference.

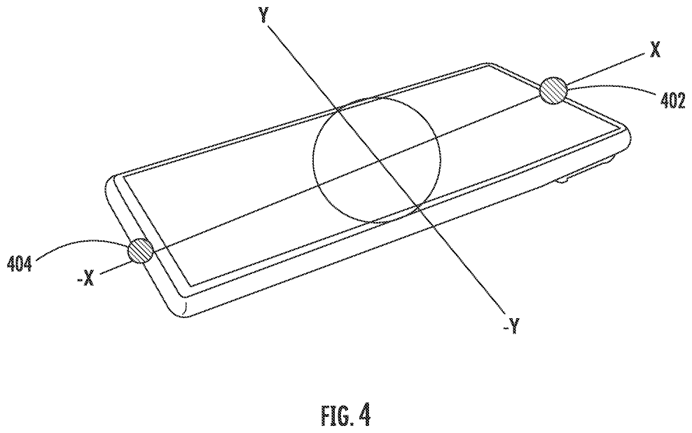

FIG. 4 is an example of a smartphone with two microphones in accordance with example embodiments of the present disclosure. As can be seen, the first microphone 402 and the second microphone 404 can be lined up along a particular axis. In this example, the first microphone 402 and the second microphone 404 are positioned at the top of the smartphone and the bottom of the smartphone respectively.

The first microphone 402 and the second microphone 404 can be aligned along the x-axis. As the phone changes orientation, the alignment of the two microphones along the x-axis can allow the audio analysis system to estimate the direction of the plurality of sound sources. The smartphone can be rotated along the x-axis, the y-axis, and the z-axis (not pictured).

In addition, the smartphone can be moved through space to another position. This movement may not be represented as a rotation along one of the three axes. Instead, positioning sensors can detect this type of movement, such as a GPS or movement sensors such as an accelerometer. These sensors can be used to determine the smartphone's orientation and position in a three-dimensional space.

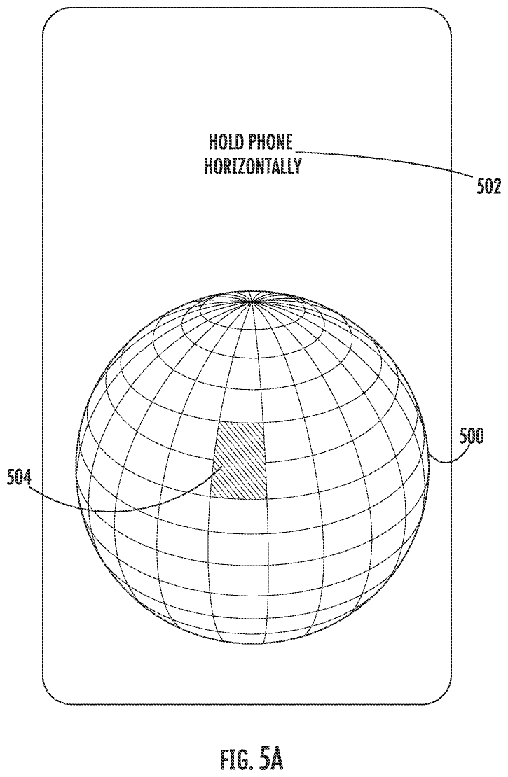

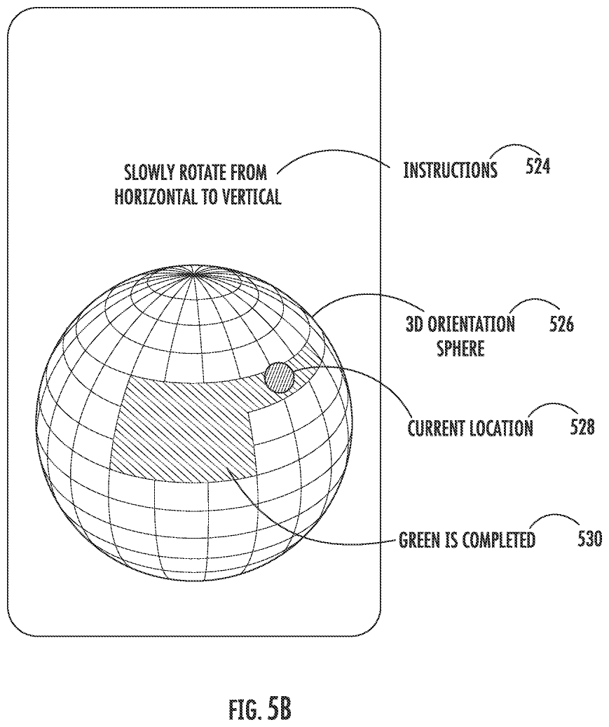

FIG. 5A is an example of a user interface for displaying movement instructions to a user in accordance with example embodiments of the present disclosure. In this example, the user interface can include a globe 500 that represents all of the possible orientations available for the user computing device (e.g., user computing device 102 in FIG. 1). The smartphone can be moved in three dimensions and rotated fully in all those dimensions.

When this user interface is initially displayed, the user interface can include an instruction 502 to “hold the phone horizontally.” The user interface can highlight a portion 504 of the globe 500 representation that represents the positions of the user computing device (e.g., user computing device 102 in FIG. 1) that have already been covered by the user in this session. Thus, when the smartphone is held horizontally a single section 504 of the globe 500 representation that is associated with the horizontal orientation can be highlighted as being used.

FIG. 5B is an example of a user interface for displaying movement instructions to a user in accordance with example embodiments of the present disclosure. In this example, the interface can include instructions 524 that update as the user computing device changes its orientation. In the current example, the displayed instructions 524 have been updated. The current instructions 524 direct the user to “Slowly rotate from horizontal to vertical.” The interface includes a spherical orientation display 526. The spherical orientation display 526 can include information as to which orientations the user computing device has been in.

In some examples, the spherical orientation display 526 is made of a plurality of tiles 530, each tile representing a specific orientation (or a small range of similar orientations). The data displayed in each respective tile can represent whether the user computing device (e.g., user computing device 102 in FIG. 1) has been placed in the corresponding respective orientation. In some examples, if a particular tile is white or clear, the user computing device (e.g., user computing device 102 in FIG. 1) has not been placed in the corresponding respective orientation. If a particular tile is filled in with a pattern or color, the user computing device (e.g., user computing device 102 in FIG. 1) has already been placed in that orientation. The current orientation 528 of the user can be marked on the globe 526 representation.

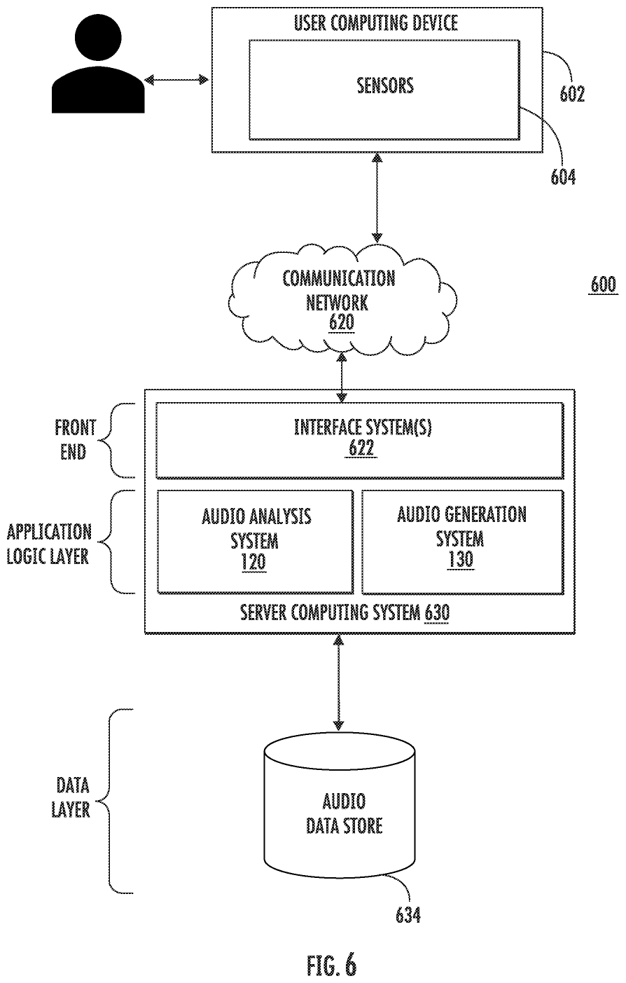

FIG. 6 depicts an example client-server environment 600 according to example embodiments of the present disclosure. The client-server system environment 600 includes one or more user computing devices 602 and a server computing system 630. One or more communication networks 620 can interconnect these components. The one or more communication networks 620 may be any of a variety of network types, including local area networks (LANs), wide area networks (WANs), wireless networks, wired networks, the Internet, personal area networks (PANs), or a combination of such networks.

A user computing device 602 can include, but is not limited to, smartphones, smartwatches, fitness bands, navigation computing devices, laptop computing devices, and embedded computing devices (computing devices integrated into other objects such as clothing, vehicles, or other objects). In some examples, a user computing device 602 can include one or more sensors intended to gather information with the permission of the user associated with the user computing device 602.

In some examples, the user computing device 602 can include one or more application(s) such as search applications, communication applications, navigation applications, productivity applications, game applications, word processing applications, or any other applications. The application(s) can include a web browser. The user computing device 602 can use a web browser (or other application) to send and receive requests to and from the server computing system 630. The application(s) can include an application that enables the user to request analysis of sensor data generated by one or more sensors 604 included in the user computing device 602.

As shown in FIG. 6, the server computing system 630 can generally be based on a three-tiered architecture, consisting of a front-end layer, application logic layer, and data layer. As is understood by skilled artisans in the relevant computer and Internet-related arts, each component shown in FIG. 6 can represent a set of executable software instructions and the corresponding hardware (e.g., memory and processor) for executing the instructions. To avoid unnecessary detail, various components and engines that are not germane to conveying an understanding of the various examples have been omitted from FIG. 6. However, a skilled artisan will readily recognize that various additional components, systems, and applications may be used with a server computing system 630, such as that illustrated in FIG. 6, to facilitate additional functionality that is not specifically described herein. Furthermore, the various components depicted in FIG. 6 may reside on a single server computer or may be distributed across several server computers in various arrangements. Moreover, although the server computing system 630 is depicted in FIG. 6 as having a three-tiered architecture, the various example embodiments are by no means limited to this architecture.

As shown in FIG. 6, the front end can consist of an interface system(s) 622, which receives communications from one or more user computing devices 602 and communicates appropriate responses to the user computing devices 602. For example, the interface system(s) 622 may receive requests in the form of Hypertext Transfer Protocol (HTTP) requests, or other web-based, application programming interface (API) requests. The user computing devices 602 may be executing conventional web browser applications or applications that have been developed for a specific platform to include any of a wide variety of computing devices and operating systems.

As shown in FIG. 6, the data layer can include an audio data store 634. The audio data store 634 can store a variety of data associated with providing audio analysis and generation services. For example, the user computing device 602 can transfer captured audio data (as well as movement data and video data if needed) to the server computing system 630. This data can be stored in the audio data store 634 until needed.

In some examples, the audio data store 634 can store data that can be used to identify a plurality of sound sources within the audio data. For example, the audio data store 634 can store any data required by the audio analysis system 120 that is used to analyze the audio data to determine a list of sound sources. Similarly, the server computing system 630 may use a classification system to classify each sound source in the list of sound sources. Data required by the classification system can be stored in the audio data store 634.

In some examples, the audio data store 634 can store sound source location estimation maps. The sound source location estimation maps can represent the sources associated with particular audio data and the estimated locations for those sound sources. The sound source location estimation maps can be stored in the audio data store 634 for use in generation of a spatial sound recording.

The application logic layer can include application data that can provide a broad range of services to users. More specifically, the application logic layer can include an audio analysis system 120 and an audio generation system.

The audio analysis system 120 can receive audio data from one or more audio sensors (e.g., microphones) at a user computing device and process that audio data to identify sources of sound within the audio data and estimate the location of those sources. The audio data can be generated as two or more streams of audio recordings from two or more audio sensors. The streams of audio data can be fed into a source identification system. The source identification system can identify distinct sound sources within audio data that includes a plurality of sound sources. The source identification system can identify individual sounds and then group them such that sounds that have originated from the same sound source are grouped together.

The source identification system can be a list of sources, and, for each respective sound source, the specific audio data associated with that respective sound source. In some examples, the two or more streams of data from two or more microphones can be compared to identify the specific sounds that occur in both microphones. The audio analysis system 120 can classify each sound source based on information in the audio data as well as any information in the movement data and video data. Sounds sources can be classified by object type (e.g., mechanical sources of sound, animal sounds, natural sounds, manmade sounds, and so on.) In some examples, the classification system can identify a particular object in the video as the sound of the source. For example, if a voice is included in the audio data the person making the sounds may be visible in the image data. The audio analysis system 120 can associate the sound with a particular person in the image video.

In some examples, the classification of a sound source can help identify the location of the sound source. For example, if a sound source is identified as rain, the audio analysis system 120 can be determined to be all around the user computing device. The location can be estimated based on this determination.

The audio analysis system 120 can estimate the location of each sound source based on comparisons of the two or more streams of audio data received from the two or more audio sensors, movement data associated with the user computing device during the recording, and video data captured while the recording was being made. In some examples, the audio data, movement data, and image data, can all have associated time data. This time data can be used to correlate sounds with specific images and particular movements. In some examples, the difference in the time at which a particular sound is detected by a first microphone and the time that the sound is detected by a second microphone can be used to estimate the direction and distance that the sound source is from the user computing device (e.g., smartphone).

In some examples, the audio generation system 130 can access the sound source location estimation map. Using the sound source location estimation map, the audio generation system 130 can generate a recording that is a spatial sound recording and intended to be played out of at least two speakers which can replicate the sonic experience of being in the three-dimensional space from which the audio was recorded. The spatial sound recording can be stored in the audio data store 634 or transferred to the user computing device 602.

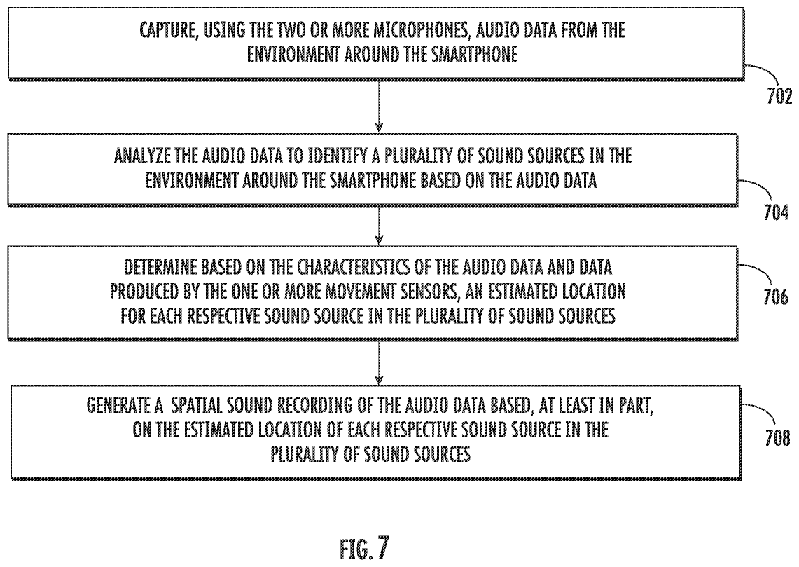

FIG. 7 is a flowchart depicting an example process of capturing audio data and generating a spatial sound recording in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1, 3, and 6.

A user computing device (e.g., user computing device 102 in FIG. 1) can include two or more two or more audio sensors and one or more movement sensors. In some examples, the user computing device (e.g., user computing device 102 in FIG. 1) can include an image sensor for capturing image data of the environment around the smartphone. The movement sensors can include an inertial measurement unit.

The user computing device (e.g., user computing device 102 in FIG. 1) can capture (at 702), using the two or more microphones, audio data from the environment around the smartphone. The audio data can include two or more streams of audio data, each stream associated with a particular microphone. The audio streams can record the same sounds but due to the placement of each microphone, the timing at which the sounds arrive at the microphone (and thus the time at which it is recorded) may differ. In some examples, the audio data includes the sounds that were recorded and the time at which those sounds were recorded. Thus, the audio data may be represented as two or more time series that represent the sound recorded at each point in the time series.

In some examples, the user computing device (e.g., user computing device 102 in FIG. 1) can analyze, at 704, the audio data to identify a plurality of sound sources in the environment around the smartphone based on the audio data. In some examples, the user computing device (e.g., user computing device 102 in FIG. 1) can determine, based on the audio data, a source type associated with a respective sound source in the plurality of sound sources. The user computing device (e.g., user computing device 102 in FIG. 1) can generate a label for the respective sound source based, at least in part, on the source type.

The user computing device (e.g., user computing device 102 in FIG. 1) can generate model input from the audio data. In some examples, the user computing device (e.g., user computing device 102 in FIG. 1) can provide the model input to a machine-learned model, wherein the machine-learned model is trained to identify specific sound sources from audio input that includes a plurality of sound sources. The user computing device (e.g., user computing device 102 in FIG. 1) can receive, from the machine-learned model, a list of sound sources.

In some examples, the audio data includes first audio data produced by a first microphone and second audio data produced by a second microphone. The user computing device (e.g., user computing device 102 in FIG. 1) can compare, for each sound source, the first sound data captured by a first microphone to the second sound data captured by a second microphone. The user computing device (e.g., user computing device 102 in FIG. 1) can estimate the location of a respective sound source based on the differences between the sound data captured by a first microphone to sound data captured by a second microphone. In some examples, the user computing device (e.g., user computing device 102 in FIG. 1) can classify the audio sources based on the characteristics of the audio data.

The user computing device (e.g., user computing device 102 in FIG. 1) can determine, at 706, based on the characteristics of the audio data and data produced by the one or more movement sensors, an estimated location for each respective sound source in the plurality of sound sources. The one or more movement sensors can measure the movement of the smartphone while the audio data is captured.

In some examples, the user computing device (e.g., user computing device 102 in FIG. 1) can correlate the movement data with the audio data to determine, for one or more points in time, the position and orientation of the smartphone. In some examples, the user computing device (e.g., user computing device 102 in FIG. 1) can estimate the location of a respective sound source in the plurality of sound sources based, at least in part, on the position and orientation of the smartphone at one or more points in time.

In some examples, the user computing device (e.g., user computing device 102 in FIG. 1) can analyze image data captured to identify one or more objects within the image data. In some examples, a machine-learned model can be used to identify one or more objects within the image data. In some examples, the user computing device (e.g., user computing device 102 in FIG. 1) can associate the one or more objects in the image data with one or more sound sources in the plurality of sound sources. For example, the user computing device (e.g., user computing device 102 in FIG. 1) can determine, for each sound source, whether the sound source is represented in the image data. In some examples, the user computing device (e.g., user computing device 102 in FIG. 1) can use the sound source classification and estimated location to identify an object in the image data that may represent the respective sound source.

In some examples, the user computing device (e.g., user computing device 102 in FIG. 1) can update the estimated location for a respective sound source associated with an object in the image data based on the position of the object within the image data. For example, the height, distance, and direction of a particular sound source can be more easily estimated based on the representation of the sound source in the image data.

The user computing device (e.g., user computing device 102 in FIG. 1) can generate, at 708, a spatial sound recording of the audio data based, at least in part, on the estimated location of each respective sound source in the plurality of sound sources.

The technology discussed herein refers to sensors and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A mobile device, the mobile device comprising:
one or more processors;
two or more audio sensors;
one or more movement sensors;
a non-transitory computer-readable memory; wherein the non-transitory computer-readable memory stores instructions that, when executed by the one or more processors, cause the mobile device to perform operations, the operations comprising:
capturing, using the two or more audio sensors, audio data from an environment around the mobile device;
analyzing the audio data to identify a plurality of sound sources in the environment around the mobile device based on the audio data;
determining, based on characteristics of the audio data and data produced by the one or more movement sensors, an estimated location for each respective sound source in the plurality of sound sources; and
generating a spatial sound recording of the audio data based, at least in part, on the estimated location of each respective sound source in the plurality of sound sources.

2. The mobile device of claim 1, wherein the movement sensors includes an inertial measurement unit.

3. The mobile device of claim 1, wherein analyzing the audio data to identify the plurality of sound sources in the environment around the mobile device based on the audio data comprises:
determining, based on the audio data, a source type associated with a respective sound source in the plurality of sound sources; and
generating a label for the respective sound source based, at least in part, on the source type.

4. The mobile device of claim 1, wherein analyzing the audio data to identify the plurality of sound sources in the environment around the mobile device based on the audio data comprises:
generating model input from the audio data;
providing the model input to a machine-learned model, the machine learned model trained to identify specific sound source from audio input that includes a plurality of sound sources; and
receiving, from the machine-learned model, a list of sound sources.

5. The mobile device of claim 1, wherein the audio data includes first audio data produced by a first microphone and second audio data produced by a second microphone each microphone.

6. The mobile device of claim 5, wherein determining, based on the characteristics of the audio data and data produced by the one or more movement sensors, an estimated location for each respective sound source in the plurality of sound sources further comprises:
comparing, for each sound source, the first audio data captured by a first microphone to the second audio data captured by a second microphone; and
estimating the location of a respective sound source based on differences between the first audio data captured by a first microphone to the second audio data captured by a second microphone.

7. The mobile device of claim 5, further comprising
for a respective sound source in the plurality of sound sources, determining, using a machine-learned classification model, a classification for the respective sound source.

8. The mobile device of claim 1, wherein the one or more movement sensors measures movement data of the mobile device while the audio data is captured.

9. The mobile device of claim 8, wherein determining, based on the characteristics of the audio data and data produced by the one or more movement sensors, the estimated location for each respective sound source in the plurality of sound sources further comprises:
correlating the movement data with the audio data to determine, for one or more points in time, a position and orientation of the mobile device; and
estimating the location for a respective sound source in the plurality of sound sources based, at least in part, on the position and orientation of the mobile device at one or more points in time.

10. The mobile device of claim 1, wherein the mobile device further comprises:
an image sensor for capturing image data of the environment around the mobile device.

11. The mobile device of claim 10, wherein determining, based on the characteristics of the audio data and data produced by the one or more movement sensors, an estimated location for each respective sound source in the plurality of sound sources further comprises:
analyzing image data captured to identify one or more objects within the image data;
associating the one or more objects in the image data with one or more sound sources in the plurality of sound sources; and
updating the estimated location for a respective sound source associated with an object in the image data based on a position of the object within the image data.

12. The mobile device of claim 1, while capturing, using the two or more audio sensors, audio data from the environment around the mobile device the operations further comprise:
determining one or more movements of the mobile device that would enable the mobile device to generate a more accurate location estimate for one or more sound sources; and
displaying instructions on a display associated with the mobile device to a user, the instructions instructing the user to make the one or more movements.

13. A computer-implemented method for recording spatial audio, the method comprising:
capturing, by a computing system including one or more processors using two or more microphones, audio data from an environment around a mobile device;
analyzing, by the computing system, the audio data to identify a plurality of sound sources in the environment around the mobile device based on the audio data;
determining, by the computing system and based on characteristics of the audio data and data produced by one or more movement sensors, an estimated location for each respective sound source in the plurality of sound sources; and
generating, by the computing system, a spatial sound recording of the audio data based, at least in part, on the estimated location of each respective sound source in the plurality of sound sources.

14. The computer-implemented method of claim 13, wherein the movement sensors includes an inertial measurement unit.

15. The computer-implemented method of claim 13, wherein analyzing the audio data to identify the plurality of sound sources in the environment around the mobile device based on the audio data comprises:
determining, by the computing system based on the audio data, a source type associated with a respective sound source in the plurality of sound sources; and
generating, by the computing system, a label for the respective sound source based, at least in part, on the source type.

16. A non-transitory computer-readable medium storing instructions that, when executed by one or more computing devices, cause the one or more computing devices to perform operations, the operations comprising:
capturing, using two or more microphones, audio data from an environment around a mobile device;
analyzing the audio data to identify a plurality of sound sources in the environment around the mobile device based on the audio data;
determining, based on characteristics of the audio data and data produced by one or more movement sensors, an estimated location for each respective sound source in the plurality of sound sources; and
generating a spatial sound recording of the audio data based, at least in part, on the estimated location of each respective sound source in the plurality of sound sources.

17. The non-transitory computer-readable medium of claim 16, wherein the audio data includes first audio data produced by a first microphone and second audio data produced by a second microphone each microphone.

18. The non-transitory computer-readable medium of claim 17, wherein determining, based on the characteristics of the audio data and data produced by the one or more movement sensors, an estimated location for each respective sound source in the plurality of sound sources further comprises:
comparing, for each sound source, the first audio data captured by a first microphone to the second audio data captured by a second microphone; and
estimating the location of a respective sound source based on one or more differences between the first audio data captured by a first microphone to the second audio data captured by a second microphone.

19. The non-transitory computer-readable medium of claim 16, further comprising
for a respective sound source in the plurality of sound sources, determining, using a machine-learned classification model, a classification for the respective sound source.

20. The non-transitory computer-readable medium of claim 16, wherein the one or more movement sensors measures movement data of the mobile device while the audio data is captured.
